(19) United States
(12) Patent Application Publication
(10) Pub. No.: US 2026/0132493 A1
(43) Pub. Date: May 14, 2026

(54) PLATED STEEL SHEET

(71) Applicant: NIPPON STEEL CORPORATION, Tokyo (JP)

(72) Inventors: Mai NAGANO, Tokyo (JP); Satoshi HIRONAKA, Tokyo (JP); Katsuya NAKANO, Tokyo (JP); Takumi OSANAI, Tokyo (JP)

(73) Assignee: NIPPON STEEL CORPORATION, Tokyo (JP)

(21) Appl. No.: 19/120,996

(22) PCT Filed: Aug. 30, 2023
(86) PCT No.: PCT/JP2023/031558

§ 371 Date: Apr. 14, 2025

(30) Foreign Application Priority Data
Jan. 13, 2023 (JP) 2023-004085

(51) Int. Cl. C22C 38/38; C21D 1/18; C21D 6/00; C21D 8/021; C21D 8/0221; C21D 8/0247; C21D 8/0278; C21D 9/46; C22C 38/00; C22C 38/02; C22C 38/04; C22C 38/06; C22C 38/22; C22C 38/24; C22C 38/26; C22C 38/28; C22C 38/32; C22C 38/34; C22C 38/42; C22C 38/44; C22C 38/48; C22C 38/50; C22C 38/54; C22C 38/58; C22C 38/60

(52) U.S. Cl. CPC C22C 38/38; C21D 1/18; C21D 6/002; C21D 6/004; C21D 6/005; C21D 6/008; C21D 8/021; C21D 8/0226; C21D 8/0263; C21D 8/0278; C21D 9/46; C22C 38/001; C22C 38/002; C22C 38/005; C22C 38/008; C22C 38/02; C22C 38/04; C22C 38/06; C22C 38/22; C22C 38/24; C22C 38/26; C22C 38/28; C22C 38/32; C22C 38/34; C22C 38/42; C22C 38/44; C22C 38/48; C22C 38/50; C22C 38/54; C22C 38/58; C22C 38/60; C21D 2211/005

(57) ABSTRACT

The present invention provides a plated steel sheet that, by having a new configuration, exhibits excellent strength and elongation and that has a further improved post-molding appearance.

A plated steel sheet according to the present invention comprises a base steel sheet and a plating layer provided on the surface of the base steel sheet. The plated steel sheet is characterized in that the base steel sheet has a specific chemical composition, the metal structure of the base steel sheet is formed of, in area %, 80-97% of ferrite and 3-20% of a hard phase, the area ratio of a band-like hard phase at a position from 3t/8 to 5t/8 in relation to the sheet thickness t is 0-5%, the absolute value of the difference in the hard phase fraction between a position from 1t/8 to 4t/8 and a position from 4t/8 to 7t/8 in relation to the sheet thickness t from the surface of the base steel sheet is 0-8%, and the surface roughness Sa of the plated steel sheet is 0.10-0.50 μm.

### FIELD

The present invention relates to plated steel sheet comprised of a base steel sheet having a plating layer on its surface.

In recent years, in the automobile industry, from the viewpoint of improvement of fuel economy etc., the need has been rising for lighter weight in not only chassis members and other structural parts, but also roofs, hoods, fenders, doors, and other panel parts. These panel parts, unlike structural parts, are visible to the human eye, therefore not only strength and other properties, but also excellent design sense, surface quality, and other aspects of the quality of appearance are being sought.

In relation to this, for example, PTL 1 discloses high strength galvanized steel sheet excellent in surface quality. Specifically, it discloses high strength galvanized steel sheet comprised of a steel sheet as a substrate having a galvanized layer on its surface, in which galvanized steel sheet, the substrate containing, by weight %, C: 0.02 to 0.20%, Si: 0.7% or less, Mn: 1.5 to 3.5%, P: 0.10% or less, S: 0.01% or less, Al: 0.1 to 1.0%, N: 0.010% or less, and Cr: 0.03 to 0.5%, having an annealed surface oxidation index A, defined by formula A=400Al/(4Cr+3Si+6Mn) with contents of Al, Cr, Si, and Mn as terms, of 2.3 or more, and having a balance of Fe and unavoidable impurities, and, further, the structure of the substrate comprising ferrite and a second phase, the second phase mainly comprised of martensite.

On the other hand, the steel sheet used for panel parts of automobiles, in response to the above need for lighter weight, are being asked to be made further higher in strength and thinner in thickness. On top of this, along with the increased complexity of shapes of panel parts, unevenness tends to more easily form at the steel sheet surfaces after shaping. If such unevenness ends up forming at the steel sheet surfaces, the quality of appearance of the panel parts is liable to fall. Specifically, for example, in the dual phase steel (below, referred to as “DP steel”) comprised of soft ferrite (soft phase) and a hard second phase (hard phase) mainly comprised of martensite such as disclosed in PTL 1, uneven deformation where the soft phase and its surroundings preferentially deform at the time of press forming or other shaping easily occurs. For this reason, if utilizing such DP steel, fine unevenness forms at the steel sheet surface after shaping and sometimes defects in appearance called “ghost lines” occur. Therefore, in DP steel, how to suppress ghost lines has become an issue.

Regarding ghost lines, for example, PTL 2 discloses steel sheet reducing Mn segregation at the time of solidification of steel so as to suppress the formation of ghost lines. Specifically, it discloses steel sheet having a specific chemical composition, having a microstructure comprised of, by area fraction, 70 to 95% of ferrite and 5 to 30% of a hard phase, and having a value X1 of the standard deviation of the mean Mn concentration in the sheet thickness direction in the rolling direction at the sheet thickness direction ¼ position divided by the mean Mn concentration in the sheet thickness direction ¼ position of 0.025 or less. In the steel sheet disclosed in this PTL 2, by great rolling reduction after solidification of the steel, the Mn segregation, in particular the microsegregation of Mn at the sheet thickness direction ¼ position, is reduced and the ratio of the connected hard phase is reduced. As a result, it is considered that the surface roughness of the steel sheet after shaping becomes better.

Further, PTL 3 discloses steel sheet having a specific chemical composition, having a microstructure comprised of a volume fraction of 70 to 95% of ferrite and a volume fraction of 5 to 30% of a hard phase, having a value X1 of a standard deviation of the Vickers hardness H¼ at the sheet thickness direction ¼ position divided by the mean value of the Vickers hardness H¼ of 0.025 or less, and having a value X2 of a standard deviation of the Vickers hardness H½ at the sheet thickness direction ½ position divided by the mean value of Vickers hardness H½ of 0.030 or less. The steel sheet of this PTL 3 is considered able to realize excellent quality of appearance in the shaped article.

PTL 4 discloses a panel having a steel sheet containing martensite, in which panel, a surface roughness parameter at a flat part of a center part of the panel (Sa, where the low pass filter λs is 0.8 mm and the 0.8 mm or less wavelength component is removed) becomes Sa≤0.500 μm, in the laths of the martensite, precipitates of a long axis of 0.05 μm to 1.00 μm and an aspect ratio of 3 or more are present in 15/μm² or more, and a ratio YS₁/YS₂ of the yield stress YS₁ measured at a tensile test piece cut out from the flat part and the yield stress YS₂ measured at a tensile test piece cut out from an end part of the panel is 0.90 to 1.10. The panel of this PTL 4 is considered a panel excellent in apparatus after shaping from a material and excellent in dent resistance.

Furthermore. PTL 5 discloses steel sheet having a specific chemical composition, having a microstructure of a surface or a surface layer region of a range from the surface to a position of 20 μm in the sheet thickness direction comprised of ferrite and a volume fraction of 0.01 to 5.0% of a second phase and having a microstructure of an inside region of a range from the surface to a position of more than 20 μm in the sheet thickness direction or from the surface to a ¼ position of sheet thickness in the sheet thickness direction comprised of ferrite and a volume fraction of 2.0 to 10.0% of a second phase, the volume fraction of the second phase of the surface layer region being smaller than the volume fraction of the second phase of the inside region, in the surface layer region, the mean crystal grain size of the second phase being 0.01 to 4.0 μm and the strength ratio X_{ODF{001}/{111}} of the {001} orientation and {111} orientation of the ferrite being 0.60 or more and less than 2.00 as texture. The steel sheet disclosed in PTL 5 is considered suppressed in occurrence of surface unevenness at the time of shaping.

### CITATIONS LIST

### Patent Literature

[PTL 1] Japanese Unexamined Patent Publication No. 2005-220430
[PTL 2] WO2022/181761
[PTL 3] WO2022/254847
[PTL 4] WO2021/149810
[PTL 5] WO2020/145256

### SUMMARY

### Technical Problem

According to the art disclosed in PTLs 2 to 5, it is considered possible to improve the surface roughness and appearance of steel sheet after shaping.

Therefore, the present invention has as its object the provision of plated steel sheet excellent in strength and elongation and having a much more improved appearance after shaping using a novel configuration.

### Solution to Problem

The inventors engaged in intensive research on a method for further alleviating ghost lines in addition to the technique of reduction of Mn segregation so as to achieve the above object. As a result, they learned that even if Mn segregation is reduced, if the segregated parts are not uniformly rolled at the front and back of the steel sheet by the hot rolling step, segregated parts end up locally concentrating at the front and back of the steel sheet and, as a result, the hard phases are not uniformly dispersed and ghost lines end up being formed. Therefore, the inventors discovered that by using a material for reducing Mn segregation and uniformly rolling the steel sheet at the front and back in the hot rolling step to make the hard phases uniformly disperse and further controlling the surface roughness of the plating layer to smooth unevenness before shaping, it is possible to maintain the high strength and elongation while suppressing the formation of ghost lines and remarkable reduce defects in the appearance after shaping.

The present invention was completed based on this finding and includes the following aspects:

### Aspect 1

Plated steel sheet comprised of
a base steel sheet and
a plating layer provided on a surface of the base steel sheet,
in which plated steel sheet,
a chemical composition of the base steel sheet further comprises, by mass %,
C: 0.03 to 0.10%,
Si: 0.01 to 1.50%,
Mn: 1.0 to 2.5%,
Al: 0.005 to 0.700%,
Cr: 0.15 to 0.80%,
Mo: 0.15 to 0.50%,
Ti: 0.03 to 0.10%,
P: 0.1000% or less,
S: 0.0200% or less,
N: 0.015% or less,
O: 0.0200% or less,
B: 0 to 0.010%,
Nb: 0 to 0.10%,
V: 0 to 0.50%,
Ni: 0 to 1.00%,
Cu: 0 to 1.00%,
W: 0 to 1.00%,
Sn: 0 to 1.00%,
Sb: 0 to 0.20%,
Ca: 0 to 0.010%,
Zr: 0 to 0.010%,
REM: 0 to 0.010%, and
bal.: Fe and impurities,
a microstructure of the base steel sheet comprises, by area %,
ferrite: 80 to 97%,
hard phases: 3 to 20%,
an area ratio of a band-like hard phase at 3t/8 to 5t/8 positions of the sheet thickness “t” is 0 to 5%,
an absolute value of a difference of hard phase fractions at 1t/8 to 4t/8 positions and 4t/8 to 7t/8 positions of the sheet thickness “t” from the surface of the base steel sheet is 0 to 8%, and
a surface roughness Sa of the plated steel sheet is 0.10 to 0.50 μm.

### Aspect 2

The plated steel sheet according to the above aspect 1, wherein the chemical composition of the base steel sheet further comprises, by mass %, one or more elements selected from the group comprising
B: 0.0001 to 0.010%,
Nb: 0.001 to 0.10%,
V: 0.001 to 0.50%,
Ni: 0.001 to 1.00%,
Cu: 0.001 to 1.00%,
W: 0.001 to 1.00%,
Sn: 0.001 to 1.00%,
Sb: 0.001 to 0.20%,
Ca: 0.0001 to 0.010%,
Zr: 0.0001 to 0.010%, and
REM: 0.0001 to 0.010%.

### Aspect 3

The plated steel sheet according to the above aspect 1 or 2, wherein, in the microstructure of the base steel sheet, the hard phases are 5% or more.

### Aspect 4

The plated steel sheet according to any one of the above aspects 1 to 3, wherein the absolute value of the difference in hard phase fractions at the 1t/8 to 4t/8 positions and 4t/8 to 7t/8 positions of sheet thickness “t” from the surface of the base steel sheet is 5% or less.

### Aspect 5

The plated steel sheet according to any one of the above aspects 1 to 4, wherein a tensile strength of the plated steel sheet is 540 MPa or more.

### Aspect 6

The plated steel sheet according to any one of the above aspects 1 to 5, wherein a mean crystal grain size of the ferrite is 5.0 to 30.0 μm and a mean crystal grain size of the hard phases is 1.0 to 5.0 μm.

### Aspect 7

The plated steel sheet according to any one of the above aspects 1 to 6, wherein the hard phases are comprised of at least one of martensite, bainite, tempered martensite, and pearlite.

### Advantageous Effects of Invention

According to the present invention, it is possible to provide high strength plated steel sheet excellent in strength and elongation and having a much more improved appearance after shaping.

### BRIEF DESCRIPTION OF DRAWINGS

FIG. 1 is a view schematically showing a partial cross-section of a plated steel sheet 1 according to an embodiment of the present invention.

FIG. 2 is a cross-sectional SEM photo of a general plated steel sheet differing from the plated steel sheet 1 of the present invention. In FIG. 2, the part shown with white arrows is the band-like hard phase.

### DESCRIPTION OF EMBODIMENTS

Below, preferred embodiments of the plated steel sheet 1 of the present invention will be explained in detail referring to the drawings. It should be noted that, in this Description, the various numerical ranges, unless particularly indicated otherwise, mean ranges including upper and lower limit values. In particular, a numerical range shown using “to” means a range including the numerical values described before and after “to” as the lower limit value and upper limit value. However, a numerical range in a case where “more than” or “less than” is attached to the numerical values described before and after the “to” means a range not including these numerical values as the lower limit value or upper limit value.

### <Plated Steel Sheet>

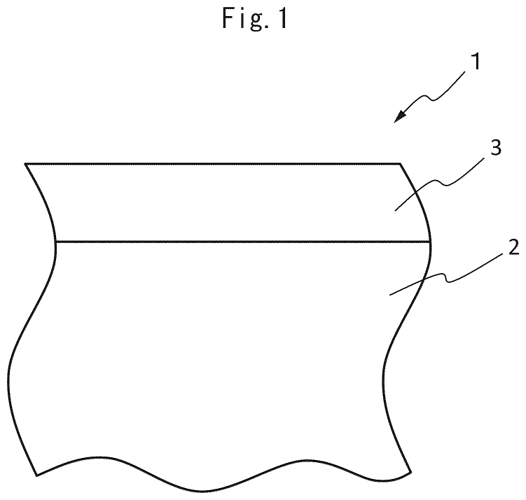

As shown in FIG. 1, the plated steel sheet 1 according to one embodiment of the present invention is a plated steel sheet comprising a base steel sheet 2 and a plating layer 3 provided at one or both of the surfaces of the base steel sheet 2. The plated steel sheet 1 of the present embodiment has the following features. In other words, one or both of the surfaces of the base steel sheet 2 are formed with a plating layer 3 having the features explained later. It should be noted that the plating layer 3 may be provided at only one surface of the base steel sheet 2 or may be provided at both.

In the plated steel sheet 1 of the present embodiment, the chemical composition of the base steel sheet 2 comprises, by mass %,
C: 0.03 to 0.10%,
Si: 0.01 to 1.50%,
Mn: 1.0 to 2.5%,
Al: 0.005 to 0.700%,
Cr: 0.15 to 0.80%,
Mo: 0.15 to 0.50%,
Ti: 0.03 to 0.10%,
P: 0.1000% or less,
S: 0.0200% or less,
N: 0.015% or less,
O: 0.0200% or less,
B: 0 to 0.010%,
Nb: 0 to 0.10%,
V: 0 to 0.50%,
Ni: 0 to 1.00%,
Cu: 0 to 1.00%,
W: 0 to 1.00%,
Sn: 0 to 1.00%,
Sb: 0 to 0.20%,
Ca: 0 to 0.010%,
Zr: 0 to 0.010%,
REM: 0 to 0.010%, and
bal.: Fe and impurities.

Further, the microstructure of the base steel sheet 2 comprises, by area %, ferrite: 80 to 97% and hard phases: 3 to 20%, has an area ratio of the band-like hard phase at the 3t/8 to 5t/8 positions of the sheet thickness “t” of 0 to 5%, and has an absolute value of difference of the hard phase fractions at the 1t/8 to 4t/8 positions and 4t/8 to 7t/8 positions of the sheet thickness “t” from the surface of the base steel sheet 2 of 0 to 8%.

Further, the surface roughness Sa of the plated steel sheet 1 of the present embodiment is 0.10 to 0.50 μm.

In roofs, hoods, fenders, doors, and other panel parts, from the viewpoint of avoiding surface defects called surface strain formed at the time of press-forming or other shaping, DP steel with relatively low yield strengths is often used. However, in DP steel comprised of a mixture of soft phases comprised of ferrite and hard phases mainly comprised of martensite etc., as explained above, uneven deformation where the soft phases and their surroundings preferentially deform at the time of press-forming or other shaping easily occurs. If fine unevenness is formed at the steel sheet surface after shaping due to such uneven deformation, defects in appearance called “ghost lines” sometimes arise.

Explaining the formation of ghost lines in more detail, first, at the time of press forming or other shaping, the soft phases comprised of ferrite deform and become recessed, while the hard phases mainly comprised of martensite etc. do not become recessed or rather are built up in projecting shapes. Due to this, fine unevenness is formed at the steel sheet surface after shaping. This fine unevenness is formed with projecting parts extending along generally the rolling direction and recessed parts extending generally along the rolling direction alternately arranged in the width direction perpendicular to the rolling direction. Further, when polishing the shaped steel sheet surface, the projecting parts of the fine unevenness of the steel sheet surface are shaved down resulting in the appearance of ghost lines of a stripe pattern extending in the rolling direction of the steel sheet.

In steel sheet like DP steel where soft phases and hard phases are mixed, hard phases connected in stripes (below, sometimes referred to as “band-like hard phase”) are present in the microstructure resulting in a marked increase in the degree of the ghost lines. Therefore, by suppressing the formation of such a band-like hard phase and making the hard phases in the microstructure disperse more uniformly, it is possible to suppress the formation of fine unevenness at the shaped steel sheet surface and suppress the formation of ghost lines.

The band-like hard phase is formed due to center segregation and microsegregation of Mn at the time of solidification of steel, therefore to suppress the formation of the band-like hard phase, it is effective to reduce the Mn segregation at the time of solidification in the casting step for solidifying molten steel to cast a slab.

However, while a certain extent of effect of improvement of ghost lines is obtained with the technique of reducing Mn segregation, the effect of improvement is not sufficient. Therefore, the inventors engaged in intensive studies on techniques for further alleviation of ghost lines in addition to the technique of reduction of Mn segregation. As a result, the inventors pinpointed the fact that even if Mn segregation were reduced, if the segregated parts are not uniformly rolled at the front and back of the steel sheet at the hot rolling step, the segregated parts will end up locally concentrating at parts of the front and back of the steel sheet and that as a result the hard phases will not be uniformly dispersed and ghost lines will end up being formed. Further, the inventors discovered that by reducing Mn segregation while rolling the steel sheet uniformly at the front and back at the hot rolling step to make the hard phases uniformly disperse and further by controlling the surface roughness of the plating layer 3 to smooth down unevenness before shaping, it is possible to suppress the formation of ghost lines while maintaining high strength and elongation and remarkably reduce defects in appearance after shaping. The present invention was completed based on such findings.

The plated steel sheet 1 according to one embodiment of the present invention, as explained above, is plated steel sheet 1 having a base steel sheet 2 and a plating layer 3 provided on a surface of the base steel sheet 2. The base steel sheet 2 has the above specific chemical composition. Furthermore, this base steel sheet 2 has a distinctive microstructure comprised of a lower hard phase fraction than conventional DP steel, having few band-like hard phase, and having little local disparity of the hard phase fractions at the front and back of the base steel sheet 2. Such a microstructure, as explained later, can be obtained by employing a specific chemical composition and production conditions to reduce the Mn segregation while uniformly rolling the front and back of the base steel sheet 2 to make the hard phases uniformly disperse.

Furthermore, in the plated steel sheet 1 of the present embodiment, as explained above, the plating layer 3 provided at the front and back of the base steel sheet 2 has a smooth surface. In other words, the plated steel sheet 1 of the present embodiment has a smooth surface. The plated steel sheet 1 having such a smooth surface, as explained later, can be obtained by selecting various conditions in the annealing step, plating step, etc.

In the plated steel sheet 1 of the present embodiment, by the base steel sheet 2 having the above such specific microstructure and having a smooth surface, it is possible to suppress the formation of ghost lines while maintaining high strength and elongation and remarkably reduce defects in appearance after shaping. In other words, according to the present embodiment, it is possible to provide plated steel sheet 1 excellent in strength and elongation and having much more improved appearance after shaping.

Below, the base steel sheet 2 and plating layer 3 forming the plated steel sheet 1 of the present embodiment will be explained in further detail. It should be noted that, in the following explanation, the “%” of the units of content of the elements mean “mass %” unless indicated otherwise.

### <Base Steel Sheet>

In the present embodiment, the base steel sheet 2, as explained above, has a specific chemical composition comprised of
C: 0.03 to 0.10%,
Si: 0.01 to 1.50%,
Mn: 1.0 to 2.5%,
Al: 0.005 to 0.700%,
Cr: 0.15 to 0.80%,
Mo: 0.15 to 0.50%,
Ti: 0.03 to 0.10%,
P: 0.1000% or less,
S: 0.0200% or less,
N: 0.015% or less,
O: 0.0200% or less,
B: 0 to 0.010%,
Nb: 0 to 0.10%,
V: 0 to 0.50%,
Ni: 0 to 1.00%,
Cu: 0 to 1.00%,
W: 0 to 1.00%,
Sn: 0 to 1.00%,
Sb: 0 to 0.20%,
Ca: 0 to 0.010%,
Zr: 0 to 0.010%,
REM: 0 to 0.010%, and
bal.: Fe and impurities.

### (Chemical Composition)

Below, the elements in this chemical composition will be explained in detail.

### [C: 0.03 to 0.10%]

C is an element forming martensite and raising the strength of the base steel sheet 2. To sufficiently obtain such an effect, the C content is 0.03% or more. The C content may also be 0.06% or more. On the other hand, from the viewpoint of not obstructing the dispersion of Mn and sufficiently suppressing the microsegregation of Mn, the C content is 0.10% or less. The C content may also be 0.09% or less.

### [Si: 0.01 to 1.50%]

Si is a deoxidizing element of steel and a solution strengthening element effective for raising the strength without detracting from the ductility of the base steel sheet 2. Further, Si is an element effective for promoting dispersion of Mn and reducing microsegregation of Mn at the time of solidification. To sufficiently obtain these effects, the Si content is 0.01% or more. The Si content may also be 0.10% or more. On the other hand, from the viewpoint of preventing surface defects due to a drop in peelability of scale, the Si content is 1.50% or less. The Si content may also be 0.50% or less.

### [Mn: 1.0 to 2.5%]

Mn is an element raising the quenchability of steel and forming martensite to contribute to increase of strength of the base steel sheet 2. To sufficiently obtain such an effect, the Mn content is 1.0% or more. The Mn content may also be 1.1% or more. On the other hand, from the viewpoint of not obstructing the dispersion of Mn and sufficiently suppressing the microsegregation of Mn, the Mn content is 2.5% or less. The Mn content may also be 2.0% or less.

### [Al: 0.005 to 0.700%]

Al is an element functioning as a deoxidizer and a solution strengthening element effective for raising the strength of the base steel sheet 2. Further, Al is an element effective for promoting dispersion of Mn and reducing microsegregation of Mn at the time of solidification. To sufficiently obtain these effects, the Al content is 0.005% or more. The Al content may also be 0.010% or more. On the other hand, from the viewpoint of preventing a drop in productivity due to deterioration of the castability, the Al content is 0.700% or less. The Al content may also be 0.080% or less.

### [Cr: 0.15 to 0.80%]

Cr is an element raising the quenchability of steel and contributing to increase of strength of the base steel sheet 2. Further, Cr is an element promoting the dispersion of Mn and reducing the microsegregation of Mn at the time of solidification. To sufficiently obtain these effects, the Cr content is 0.15% or more. The Cr content may also be 0.20% or more. On the other hand, from the viewpoint of preventing the formation of coarse Cr carbides which can become starting points of fracture, the Cr content is 0.80% or less. The Cr content may also be 0.40% or less.

### [Mo: 0.15 to 0.50%]

Mo is an element suppressing phase transformation at a high temperature and contributing to increase of strength of the base steel sheet 2. Further, Mo is an element effective for promoting diffusion of Mn and reducing microsegregation of Mn at the time of solidification. To sufficiently obtain these effects, the Mo content is 0.15% or more. The Mo content may also be 0.20% or more. On the other hand, from the viewpoint of preventing a drop in productivity due to a drop in hot workability, the Mo content is 0.50% or less. The Mo content may also be 0.40% or less.

### [Ti: 0.03 to 0.10%]

Ti is an element having the effect of reduction of the amounts of S, N, and O enabling formation of coarse inclusions acting as starting points of fracture. Further, Ti is a precipitation strengthening element refining the structure and having the effect of improving the strength-shapeability balance of the base steel sheet 2. To sufficiently obtain these effects, the Ti content is 0.03% or more. The Ti content may also be 0.05% or more. On the other hand, from the viewpoint of preventing a drop in shapeability of the base steel sheet 2 due to formation of coarse Ti sulfides, Ti nitrides, and/or Ti oxides, the Ti content is 0.10% or less. The Ti content may also be 0.08% or less.

### [P: 0.1000% or Less]

P is an element entering in the production process. Further, P is a solution strengthening element. The P content may be 0%. However, for reduction of the P content to 0%, time is required for refining and a drop in productivity is invited. Therefore, from the viewpoint of productivity, the P content may also be 0.0001% or more or 0.0005% or more. On the other hand, from the viewpoint of preventing a drop in toughness of the base steel sheet 2, the P content is 0.1000% or less. The P content may also be 0.0150% or less.

### [S: 0.0200% or Less]

S is an element entering in the production process. The S content may be 0%. However, for reduction of the S content to 0%, time is required for refining and a drop in productivity is invited. Therefore, from the viewpoint of productivity, the S content may also be 0.0001% or more or 0.0005% or more. On the other hand, from the viewpoint of preventing a drop in ductility, hole expandability, stretch flangeability, and/or bendability and other shapeability of the base steel sheet 2 due to formation of Mn sulfides, the S content is 0.0200% or less. The S content may also be 0.0100% or less.

### [N: 0.015% or Less]

N is an element entering in the production process. The N content may be 0%. However, for reduction of the N content to 0%, time is required for refining and a drop in productivity is invited. Therefore, from the viewpoint of productivity, the N content may also be 0.0001% or more or 0.0005% or more. On the other hand, from the viewpoint of preventing a drop in the ductility, hole expandability, stretch flangeability, and/or bendability and other shapeability of the base steel sheet 2 due to the formation of nitrides, the N content is 0.015% or less. The N content may also be 0.008% or less.

### [O: 0.0200% or Less]

O is an element entering in the production process. The O content may be 0%. However, for reduction of the O content to 0%, time is required for refining and a drop in productivity is invited. Therefore, from the viewpoint of productivity, the O content may also be 0.0001% or more or 0.0005% or more. On the other hand, from the viewpoint of preventing a drop in the ductility, hole expandability, stretch flangeability, and/or bendability and other shapeability of the base steel sheet 2 due to the formation of coarse oxides, the O content is 0.0200% or less. The O content may also be 0.0010% or less.

The basic chemical composition of the base steel sheet 2 of the present embodiment is as explained above. Further, in the present embodiment, the base steel sheet 2 may contain one or more of any of the following elements in place of part of the Fe of the balance in accordance with need. Below, these optional elements will be explained in detail.

### [B: 0 to 0.010%]

B is an element forming martensite and contributing to increase of strength of the base steel sheet 2. The B content may be 0%, but to sufficiently obtain such an effect, the B content may also be 0.0001% or more or 0.0005% or more. On the other hand, from the viewpoint of preventing a drop in strength of the base steel sheet 2 by formation of precipitates, the B content is 0.010% or less. The B content may also be 0.004% or less.

### [Nb: 0 to 0.10%]

Nb is an element contributing to improvement of strength of the base steel sheet 2 by strengthening by precipitates, strengthening by refinement by suppressing growth of ferrite grains, and/or strengthening by dislocations by suppressing recrystallization. The Nb content may be 0%, but to sufficiently obtain these effects, the Nb content may also be 0.001% or more or 0.005% or more. On the other hand, from the viewpoint of preventing a drop in shapeability of the base steel sheet 2 by increase of nonrecrystallized ferrite, the Nb content is 0.10% or less. The Nb content may also be 0.08% or less.

### [V: 0 to 0.50%]

V is an element contributing to improvement of strength of the base steel sheet 2 by strengthening by precipitates, strengthening by refinement by suppressing growth of ferrite grains, and/or strengthening by dislocations by suppressing recrystallization. The V content may be 0%, but to sufficiently obtain these effects, the V content may also be 0.001% or more or 0.005% or more. On the other hand, from the viewpoint of preventing a drop in shapeability of the base steel sheet 2 by precipitation of a large amount of carbonitrides, the V content is 0.50% or less. The V content may also be 0.01% or less.

### [Ni: 0 to 1.00%]

Ni is an element suppressing phase transformation at a high temperature and contributing to improvement of the strength of the base steel sheet 2. The Ni content may be 0%, but to sufficiently obtain such an effect, the Ni content may also be 0.001% or more or 0.005% or more. On the other hand, from the viewpoint of preventing a drop in weldability of the base steel sheet 2, the Ni content is 1.00% or less. The Ni content may also be 0.40% or less.

### [Cu: 0 to 1.00%]

Cu is an element present in steel in the form of fine grains and contributes to improvement of the strength of the base steel sheet 2. The Cu content may be 0%, but to sufficiently obtain such an effect, the Cu content may also be 0.001% or more or 0.005% or more. On the other hand, from the viewpoint of preventing a drop in weldability of the base steel sheet 2, the Cu content is 1.00% or less. The Cu content may also be 0.40% or less.

### [W: 0 to 1.00%]

W is an element suppressing phase transformation at a high temperature and contributing to improvement of the strength of the base steel sheet 2. The W content may be 0%, but to sufficiently obtain such an effect, the W content may also be 0.001% or more or 0.005% or more. On the other hand, from the viewpoint of preventing a drop in productivity due to a drop in the hot workability, the W content is 1.00% or less. The W content may also be 0.08% or less.

### [Sn: 0 to 1.00%]

Sn is an element suppressing coarsening of grains and contributing to improvement of strength of the base steel sheet 2. The Sn content may be 0%, but to sufficiently obtain such an effect, the Sn content may also be 0.001% or more or 0.005% or more. On the other hand, from the viewpoint of preventing embrittlement of the base steel sheet 2 by formation of coarse oxides, the Sn content is 1.00% or less. The Sn content may also be 0.08% or less.

### [Sb: 0 to 0.20%]

Sb is an element suppressing coarsening of grains and contributing to improvement of strength of the base steel sheet 2. The Sb content may be 0%, but to sufficiently obtain such an effect, the Sb content may also be 0.001% or more or 0.005% or more. On the other hand, from the viewpoint of preventing embrittlement of the base steel sheet 2 by formation of coarse oxides, the Sb content is 0.20% or less. The Sb content may also be 0.04% or less.

### [Ca: 0 to 0.010%]

Ca is an element entering as a deoxidizing material. The Ca content may be 0%, but for reduction of the Ca content to 0%, time is required for refining and a drop in productivity is invited. Therefore, from the viewpoint of productivity, the Ca content may also be 0.0001% or more or 0.0005% or more. On the other hand, from the viewpoint of preventing embrittlement of the base steel sheet 2 by formation of coarse oxides, the Ca content is 0.010% or less.

### [Zr: 0 to 0.010%]

Zr is an element entering as a deoxidizing material. The Zr content may be 0%, but for reduction of the Zr content to 0%, time is required for refining and a drop in productivity is invited. Therefore, from the viewpoint of productivity, the Zr content may also be 0.0001% or more or 0.0005% or more. On the other hand, from the viewpoint of preventing embrittlement of the base steel sheet 2 by formation of coarse oxides, the Zr content is 0.010% or less.

### [REM: 0 to 0.010%]

REM is an element entering as a deoxidizing material. The REM content may be 0%, but to sufficiently obtain such an effect, the REM content may also be 0.0001% or more or 0.0005% or more. On the other hand, from the viewpoint of preventing embrittlement of the base steel sheet 2 by formation of coarse oxides, the REM content is 0.010% or less.

It should be noted that, in this Description, “REM” is the general name of the 17 elements of atomic number 21 scandium (Sc), atomic number 39 yttrium (Y), and the lanthanoid atomic number 57 lanthanum (La) to atomic number 71 lutetium (Lu). The REM content is the total content of these elements.

Regarding the above optional elements, in the present embodiment, the chemical composition of the base steel sheet 2 may include, by mass %, one or more elements selected from the group comprising
B: 0.0001 to 0.010%,
Nb: 0.001 to 0.10%,
V: 0.001 to 0.50%,
Ni: 0.001 to 1.00%,
Cu: 0.001 to 1.00%,
W: 0.001 to 1.00%,
Sn: 0.001 to 1.00%,
Sb: 0.001 to 0.20%,
Ca: 0.0001 to 0.010%,
Zr: 0.0001 to 0.010%, and
REM: 0.0001 to 0.010%.

In the present embodiment, the balance of the base steel sheet 2 besides the above elements is comprised of Fe and impurities. Here, the “impurities” are constituents etc. entering due to various factors in the production process such as first and foremost the ore, scrap, and other such raw materials when industrially producing the base steel sheet 2. As impurities, for example, H, Na, Cl, Co, Zn, Ga, Ge, As, Se, Y, Tc, Ru, Rh, Pd, Ag, Cd, In, Te, Cs, Ta, Re, Os, Ir, Pt, Au, Pb, Bi, and Po may be mentioned. The impurities may be included in a total amount of 0.100% or less.

Here, the chemical composition of the base steel sheet 2 may be measured by a general analysis method. For example, the chemical composition of the base steel sheet 2 may be measured using inductively coupled plasma-atomic emission spectrometry (ICP-AES). C and S can be measured using the combustion-infrared absorption method, N using the inert gas melting-thermal conductivity method, and O using the inert gas melting-nondispersive type infrared absorption method.

### (Microstructure)

### [Ferrite: 80 to 97% and Hard Phases: 3 to 20%]

In the present embodiment, the microstructure of the base steel sheet 2 comprises, by area %, 80 to 97% of ferrite and 3 to 20% of hard phases. By the microstructure of the base steel sheet 2 being such a composite structure, the strength and ductility (elongation) of the base steel sheet 2 can be maintained in suitable ranges, specifically, the tensile strength and elongation at break measured using a No. 5 test piece of JIS Z 2241:2022 having a direction perpendicular to the rolling direction as a long direction can be maintained in the respective ranges of 540 MPa or more tensile strength and 19% or more elongation at break, while defects in appearance after shaping can be easily suppressed.

From the viewpoint of further raising the strength of the base steel sheet 2, the area fraction of the hard phases (below, sometimes referred to as the “hard phase fraction”) is 4% or more, 5% or more, or 6% or more. Similarly, the area fraction of ferrite (below, sometimes referred to as the “ferrite fraction”) is 96% or less, 95% or less, or 94% or less.

On the other hand, from the viewpoint of further raising the ductility (elongation) of the base steel sheet 2, the hard phase fraction is 8% or less or 10% or less. Similarly, the ferrite fraction is 90% or more or 92% or more.

In this Description, the “hard phases” of the base steel sheet 2 means structures harder than ferrite and are, for example, comprised of at least one of martensite, bainite, tempered martensite, and pearlite. From the viewpoint of improvement of the strength of the base steel sheet 2, the hard phases are preferably comprised of at least one of martensite, bainite, and tempered martensite, more preferably are comprised of martensite. It should be noted that the microstructure of the base steel sheet 2 preferably has little retained austenite. Specifically, the retained austenite is preferably, by area %, 3% or less, 1% or less, or 0.5% or less, more preferably is 0%.

### (Identification of Microstructure and Calculation of Area Fractions)

The microstructure of the base steel sheet 2 is identified and the area fractions are calculated in the following way. First, a sample for examination of the microstructure (size of about 20 mm in rolling direction×50 mm in width direction×thickness of base steel sheet) is taken from a position 100 mm or more separated from the end faces of the base steel sheet 2 from which the plating layer 3 has been removed. For conditioning the sample, a sheet thickness cross-section in the rolling perpendicular direction is polished as the examined surface and etched by Nital corrosion. Next, a scan type electron microscope (SEM) is used to capture secondary electron images of the examined surface of the sample by a power of 600× then connect the same. The obtained image data is examined in 10 fields at regions of the total sheet thickness×5 mm. “Photoshop™ CS5” image analysis software made by Adobe is used for image analysis. In the image analysis, the ferrite and hard phases are binarized by the differences in brightness and the area fraction of the hard phases is calculated. It should be noted that the black parts of the image data are ferrite and the white parts are the hard phases. The total 10 locations of examined fields are analyzed by image analysis in the same way as above to measure the area fractions of the hard phases. The mean value of these area fractions is calculated. The mean value is made the area fraction of the hard phases. The remainder is made the area fraction of the ferrite. It should also be noted that the overall examined area becomes total sheet thickness×50 mm.

In this case, in this Description, the rolling direction of the base steel sheet 2 can, for example, be judged as follows. The. sheet thickness cross-section is finished by polishing it to a mirror surface, then the S concentration is measured by an electron probe micro analyzer (EPMA). The measurement conditions are measurement by an acceleration voltage of 15 kV, a measurement pitch of 1 μm, and an image of the distribution in a 500 μm square range at the 3t/8 to 5t/8 positions of the sheet thickness “t”. At this time, a stretched region with a high S concentration is judged to be an inclusion. At the time of examination, a plurality of fields may also be examined. Next, using the sheet thickness cross-section first examined by the above method as a reference, planes parallel with planes rotating about the sheet thickness direction axis by 5° increments in the 0° to 180° range are examined in cross-section by a method similar to the above. At each of the obtained cross-sections, the mean value of the lengths of long axes of a plurality of inclusions is calculated. Further, the cross-section with the largest mean value of the lengths of the long axes of inclusions is identified. The direction parallel to the long axis direction of the inclusions at that cross-section is judged to be the rolling direction.

It should be noted that, in the case of a coil or the case where the rolling direction of the base steel sheet 2 can be grasped by another means, the rolling direction of the base steel sheet 2 does not have to be judged by the above method of judgment.

Regarding the calculation of the area fractions of the microstructure, if measurement of the area fraction of the retained austenite is necessary, it is possible to measure the area fraction of the retained austenite by X-ray diffraction of the observed surface. Specifically, Co-Kα rays are used to find the integral strength of the total six peaks of α(110), α(200), α(211), γ(111), γ(200), and γ(220) at the sheet thickness direction ¼ position. The strength averaging method is used to calculate the volume fraction of the retained austenite and the volume fraction of the obtained retained austenite is made the area fraction of the retained austenite.

[Area Ratio of Band-Like Hard Phase at 3t/8 to 5t/8 Positions of Sheet Thickness “t” of 0 to 5%]

In the present embodiment, the microstructure of the base steel sheet 2 has an area ratio of the band-like hard phase at the 3t/8 to 5t/8 positions of the sheet thickness “t” of 0 to 5%. By reducing the band-like hard phase contained in the microstructure in this way, i.e., by making the hard phases more uniformly dispersed, it is possible to prevent the strain at the time of shaping from becoming uneven and suppress the formation of fine unevenness at the surface of the shaped plated steel sheet 1. Due to this, it is possible to make occurrence of ghost lines harder.

### (Band-Like Hard Phase)

In this Description, “band-like hard phase” means one or more bands of hard phases having 3 μm or more thicknesses and 200 μm or more lengths and extending continuously or intermittently. In this case, “thickness” means the length in the sheet thickness direction and “length” means the length in the direction perpendicular to the sheet thickness. It should be noted that, if there are a plurality of line-like hard phases present, a plurality of line-like hard phases with a total thickness of 3 μm or more is a “band-like hard phase”.

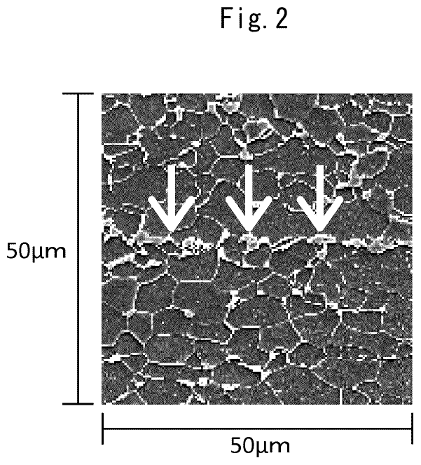

In this case. FIG. 2 is a cross-sectional SEM photo of general plated steel sheet different from the plated steel sheet 1 of the present invention. In FIG. 2, the part shown by the white arrows is the band-like hard phase.

(Method of Measurement of Area Ratio of Band-Like Hard Phase at 3t/8 to 5t/8 Positions of Sheet Thickness “t”)

The area ratio of the band-like hard phase at the 3t/8 to 5t/8 positions of the sheet thickness “t” can be measured as follows: First, the connected SEM image measured at the above “Identification of Microstructure and Calculation of Area Fractions”, i.e., the image data obtained by capturing and connecting secondary electron images of the observed surface of the sample at a power of 600×, is analyzed at 10 fields in regions of the total sheet thickness×5 mm (total fields of total sheet thickness×50 mm) using the image analysis software of “Photoshop™ CS5” made by Adobe, and the area ratio of the one or more bands of hard phase, i.e., band-like hard phase, having the above-mentioned 3 μm or more thicknesses and 200 μm or more lengths at the 3t/8 to 5t/8 positions of sheet thickness “t” forming the center part and extending continuously or intermittently is calculated.

The area ratio of the band-like hard phase at the 3t/8 to 5t/8 positions of the sheet thickness “t” is preferably 3% or less from the viewpoint of further improvement of the appearance after shaping, more preferably 2% or less or 1% or less, particularly preferably 0%.

[Absolute Value of Difference of Hard Phase Fractions at it/8 to 4t/8 Positions and 4t/8 to 7t/8 Positions of Sheet Thickness “t” from Surface of Base Steel Sheet of 0 to 8%]

In the present embodiment, the microstructure of the base steel sheet 2 has an absolute value of the difference of the hard phase fractions at the 1t/8 to 4t/8 positions and 4t/8 to 7t/8 positions of sheet thickness “t” from the surface of the base steel sheet 2 of 0 to 8%. It should be noted that, “absolute value of the difference of the hard phase fractions of 0 to 8%” is synonymous with “difference of the hard phase fractions of −8 to 8%”. In the present embodiment, by making the local disparity of the hard phase fractions at the front and back of the base steel sheet 2 smaller in this way, it is possible to prevent strain at the time of shaping from becoming uneven and suppress the formation of fine unevenness at the surface of the shaped plated steel sheet 1. Due to this, it is possible to make the formation of ghost lines more difficult.

The difference of the absolute values of the hard phase fractions at the 1t/8 to 4t/8 positions and 4t/8 to 7t/8 positions of sheet thickness “t” from the surface of the base steel sheet 2 can be calculated by finding the area ratio of the hard phases at the 1t/8 to 4t/8 positions of sheet thickness “t” from the surface of the base steel sheet 2 and the area ratio of the hard phases at the 4t/8 to 7t/8 positions of sheet thickness “t” from the surface of the base steel sheet 2 from the connected SEM image measured in the above “Identification of Microstructure and Calculation of Area Fractions” and obtaining the difference.

The absolute value of the difference of the hard phase fractions at the 1t/8 to 4t/8 positions and 4t/8 to 7t/8 positions of sheet thickness “t” from the surface of the base steel sheet 2 is preferably 6% or less from the viewpoint of further improvement of the appearance after shaping, more preferably 5% or less, still more preferably 4% or less, particularly preferably 1% or less.

[Mean Crystal Grain Size of Ferrite: 5.0 to 30.0 μm]

The mean crystal grain size of ferrite in the base steel sheet 2 is the mean size of the ferrite formed at the time of annealing. The density and crystal grain size of the hard phases change in accordance with the mean crystal grain size of the ferrite. In the present embodiment, the mean crystal grain size of the ferrite is preferably 5.0 to 30.0 μm. By controlling the mean crystal grain size of the ferrite to such a fine range, the structure rises in uniformity and the appearance after shaping can be further improved. Specifically, if the mean crystal grain size of the ferrite is 5.0 μm or more, aggregation of the hard phases after formation of ferrite becomes harder, strain at the time of shaping can be prevented from becoming uneven, and the appearance after shaping can be further improved. On the other hand, if the mean crystal grain size of ferrite is 30.0 μm or less, the variation in size of ferrite becomes smaller, strain at the time of shaping can be prevented from becoming uneven, and the appearance after shaping can be further improved. The mean crystal grain size of ferrite is 8.0 μm or more, 10.0 μm or more, or 12.0 μm or more. Similarly the mean crystal grain size of ferrite is 28.0 μm or less, 25.0 μm or less, or 21.0 μm or less.

The mean crystal grain size of the ferrite at the base steel sheet 2 can be measured as follows: First, the connected SEM image measured at the above “Identification of Microstructure and Calculation of Area Fractions”. i.e., the image data obtained by capturing and connecting secondary electron images of the observed surface of the sample at a power of 600×, is analyzed at 10 fields in regions of the total sheet thickness×5 mm (total fields of total sheet thickness×50 mm) using the image analysis software of “Photoshop™ CS5” made by Adobe, and the numbers of grains of ferrite at the 10 fields are respectively calculated. The overall area ratio of the ferrite (i.e., the total area ratio of ferrite at the 10 fields) is divided by the total number of grains of ferrite at the 10 fields to calculate the mean area ratio per ferrite grain. From this mean area ratio, the circle equivalent diameter is calculated. The obtained circle equivalent diameter is made the mean crystal grain size of the ferrite.

[Mean Crystal Grain Size of Hard Phases: 1.0 to 5.0 μm]

The mean crystal grain size of the hard phases at the base steel sheet 2 is the mean size of the martensite, pearlite, bainite, retained austenite, and other hard phases formed at the time of annealing. In the present embodiment, the mean crystal grain size of the hard phases is preferably 1.0 to 5.0 μm. By controlling the mean crystal grain size of the hard phases to within such a fine range, the structure rises in uniformity and the appearance after shaping can be further improved. Specifically, if the mean crystal grain size of the hard phases is 1.0 μm or more, aggregation of the hard phases becomes difficult, strain at the time of shaping can be prevented from becoming uneven, and the appearance after shaping can be further improved. On the other hand, if the mean crystal grain size of the hard phases is 5.0 μm or less, the variation in the size of the hard phases is reduced, the strain at the time of shaping can be prevented from becoming uneven, and the appearance after shaping can be further improved. The mean crystal grain size of the hard phases is 1.5 μm or more. Similarly, the mean crystal grain size of the hard phases is 4.8 μm or less or 4.5 μm or less.

The mean crystal grain size of the hard phases can be measured as follows: First, the connected SEM image measured at the above “Identification of Microstructure and Calculation of Area Fractions”, i.e., the image data obtained by capturing and connecting secondary electron images of the observed surface of the sample at a power of 600×, is analyzed at 10 fields in regions of the total sheet thickness×5 mm (total fields of total sheet thickness×50 mm) using the image analysis software of “Photoshop™ CS5” made by Adobe, and the numbers of grains of the hard phases at the 10 fields are respectively calculated. The overall area ratio of the hard phases (i.e., the total area ratio of grains of the hard phases at the 10 fields) is divided by the total number of grains of the hard phases at the 10 fields to calculate the mean area ratio per hard phase grain. From this mean area ratio, the circle equivalent diameter is calculated. The obtained circle equivalent diameter is made the mean crystal grain size of the hard phases.

### (Sheet Thickness)

In the present embodiment, the sheet thickness of the plated steel sheet 1 is not particularly limited, but, for example, the plated steel sheet 1 may have a 0.1 to 2.0 mm sheet thickness. The plated steel sheet 1 having such a sheet thickness is suitable for cases of use as material of doors, hoods, and other panel parts. It should be noted that, the sheet thickness of the plated steel sheet 1 is 0.2 mm or more, 0.3 mm or more, or 0.4 mm or more. Similarly, the sheet thickness of the plated steel sheet 1 is 1.8 mm or less, 1.5 mm or less, 1.2 mm or less, or 1.0 mm or less. For example, by making the sheet thickness of the plated steel sheet 1 0.2 mm or more, keeping the shape of the shaped article smooth becomes easy and the additional effect of improvement of the dimensional accuracy and shape accuracy can be obtained. On the other hand, by making the sheet thickness 1.0 mm or less, the effect of lightening the member becomes remarkable. The sheet thickness of the plated steel sheet 1 is, for example, measured by a micrometer.

### <Plating Layer>

In the present embodiment, the plating layer 3 formed on a surface of the base steel sheet 2 may be either of a hot dip coated layer and an electroplated layer. As the hot dip coated layer, for example, a hot dip galvanized layer (GI), hot dip galvannealed layer (GA), hot dip aluminum coated layer, hot dip Zn—Al alloy coated layer, hot dip Zn—Al—Mg alloy coated layer, hot dip Zn—Al—Mg—Si alloy coated layer, etc. may be mentioned. As the electroplated layer, for example, an electrogalvanized layer (EG), electro Zn—Ni alloy plating layer, etc. may be mentioned. Among these as well, the plating layer 3 is preferably a hot dip galvanized layer, hot dip galvannealed layer, or electrogalvanized layer.

### [Surface Roughness Sa of Plated Steel Sheet of 0.10 to 0.50 Um]

In the present embodiment, the surface roughness Sa of the plated steel sheet 1 (surface roughness of plating layer 3 provided at surface of base steel sheet 2) is 0.10 to 0.50 μm. By controlling the surface roughness of the plated steel sheet 1 in this way and smoothing unevenness at the surface of the plated steel sheet 1 before shaping, it is possible to keep the unevenness of the shaped surface from standing out. Due to this, it is possible to more reliably reduce defects in appearance after shaping.

In the present embodiment, the surface roughness Sa of the plated steel sheet 1 is preferably 0.45 μm or less from the viewpoint of further improvement of the appearance after shaping, more preferably 0.43 μm or less, still more preferably 0.35 μm or less, particularly preferably 0.33 μm or less. Further, the surface roughness Sa of the plated steel sheet 1 is 0.20 μm or more or 0.25 μm or more.

The surface roughness Sa of the plated steel sheet 1 can be measured in the following way. First, a test piece is taken from the plated steel sheet 1 to be measured. At this time, the test piece is taken from a position 100 mm or more separated from the end faces of the plated steel sheet 1. Next, a laser microscope is used to measure the unevenness of the test piece surface in 8 mm×8 mm regions. The measurement conditions at this time are a measurement power of 20×, a resolution of the XY plane of 5 μm, and a resolution of the Z spatial plane of 0.1 nm for measurement connected. After that, the entire measurement region is filtered to remove unevenness of a period of 0.25 mm or less (i.e., low pass filter λs of 0.25 mm). The arithmetic mean height Sa is found in accordance with JIS B0681-2:2018, 4.1.7, “arithmetical mean height of the scale limited surface”.

The thus obtained arithmetic mean height Sa is made the surface roughness Sa of the plated steel sheet 1. It should be noted that, the surface roughness Sa becomes greater the smaller the low pass filter λs, for example, in steel sheet for automotive use where good appearance is necessary, the Sa (λs=0.25 mm) when the low pass filter λs is 0.25 mm becomes about 3 times the Sa (λs=0.8 mm) when the low pass filter λs is 0.8 mm. For this reason, the surface roughness of 0.10 to 0.50 μm by Sa (λs=0.25 mm) means extremely little unevenness of the surface and smooth surface properties.

In the present embodiment, the amount of deposition of the plating layer 3 is a 20 g/m² or more amount of deposition as the amount of deposition per single surface of the base steel sheet 2 from the viewpoint of adjusting the surface roughness Sa of the plated steel sheet 1 to 0.10 to 0.50 μm. If the amount of deposition of the plating layer 3 is 20 g/m² or more, the surface of the base steel sheet 2 can be formed with the plating layer 3 more uniformly and the appearance after shaping can be improved. Further, the amount of deposition of the plating layer 3 is 120 g/m² or less from the viewpoint of adjusting the surface roughness Sa of the plated steel sheet 1 to 0.10 to 0.50 μm. If the amount of deposition of the plating layer 3 is 120 g/m² or less, the adhesion of the plating layer 3 becomes further higher. The amount of deposition of the plating layer 3 is 25 g/m² or more or 30 g/m² or more. Similarly, the amount of deposition of the plating layer 3 is 110 g/m² or less or 100 g/m² or less.

### (Mechanical Properties)

According to the plated steel sheet 1 of the present embodiment comprised of the base steel sheet 2 having the above specific chemical composition and microstructure and the plating layer 3 provided at its surface and having a specific surface roughness, a high strength, specifically a 540 MPa or more tensile strength, and excellent ductility (elongation), specifically 19% or more elongation at break, can be achieved. In this case, the tensile strength and elongation at break are the tensile strength and elongation at break measured using a No. 5 test piece of JIS Z 2241:2022 cut out from the plated steel sheet 1 and having a direction perpendicular to the rolling direction as the long direction.

### (Tensile Strength)

The tensile strength of the plated steel sheet 1 is preferably 540 MPa or more. The tensile strength of the plated steel sheet 1 is more preferably 550 MPa or more or 600 MPa or more. The upper limit of the tensile strength of the plated steel sheet 1 is not particularly prescribed, but, for example, the tensile strength is 980 MPa or less or 850 MPa or less. If the tensile strength is 850 MPa or less, there is the advantage that the shapeability when press forming the plated steel sheet 1 becomes easy to secure.

### (Elongation at Break)

The elongation at break of the plated steel sheet 1 is preferably 19% or more from the viewpoint of the shapeability. The elongation at break of the plated steel sheet 1 is more preferably 20% or more or 21% or more. The upper limit of the elongation at break of the plated steel sheet 1 is not particularly prescribed, but from the viewpoint of productivity, for example, the elongation at break is 35% or less or 33% or less.

The tensile strength (TS) and elongation at break can be measured as follows: First, a No. 5 test piece of JIS Z2241: 2022 having a direction perpendicular to the rolling direction as a long direction is taken from the center part of the width of the plated steel sheet 1 to be measured. Next, this test piece can be subjected to a tensile test based on JIS Z 2241:2022 to thereby measure the tensile strength TS (MPa) and elongation at break EL (%).

(Surface Properties after Shaping)

Furthermore, the plated steel sheet 1 of the present embodiment has an Sa after shaping of 0.10 to 0.50 μm and a Str after shaping of 0.30 to 1.00, i.e., excellent surface properties after shaping. For this reason, according to the plated steel sheet 1 of the present embodiment, excellent appearance after shaping can be obtained.

(Sa after Shaping of 0.10 to 0.50 Um)

As explained above, the plated steel sheet 1 of the present embodiment can have surface properties giving an Sa after shaping becoming 0.10 to 0.50 μm. The Sa after shaping s a mean value of the height differences (absolute values) of different points from the mean plane of the surface after imparting strain at the time of shaping. If the shaped Sa is 0.50 μm or less, the appearance after shaping becomes excellent. It should be noted that the Sa after shaping is 0.10 μm or more from the viewpoint of productivity.

The Sa after shaping can be measured as follows: First, a No. 5 test piece of JIS Z2241: 2022 having a direction perpendicular to the rolling direction as a long direction is taken from the plated steel sheet 1 to be measured. At this time, the test piece is taken from a position 100 mm or more separated from the end faces of the plated steel sheet 1. Next, by a tensile test based on JIS Z 2241:2022, the above test piece is given a 5% tensile strain in the long direction. Further, a laser microscope is used to measure the unevenness of the test piece surface after the tensile test in 8 mm×8 mm regions. The measurement conditions at this time are a measurement power of 20×, a resolution of the XY plane of 5 μm, and a resolution of the Z spatial plane of 0.1 nm for measurement connected. After that, the entire measurement region is filtered to remove unevenness of a period of 0.25 mm or less (i.e., low pass filter λs of 0.25 mm). The arithmetic mean height Sa is found by a method similar to the surface roughness Sa of the plated steel sheet 1 explained above. The thus obtained arithmetic mean height Sa is made the Sa after shaping.

(Str after Shaping of 0.30 to 1.00)

As explained above, the plated steel sheet 1 of the present embodiment can have surface properties giving a Str after shaping becoming 0.30 to 1.00. The “Str after shaping” is an indicator taking a value of 0 to 1 in range expressing the anisotropy of surface unevenness after strain is imparted at the time of shaping. It should be noted that, Str, which is an aspect ratio of the surface properties, is one of the spatial parameters of the surface properties prescribed by the “texture aspect ratio” of 4.2.2 of JIS B0681-2:2018 and is known to indicate the strength of anisotropy of the surface and take a value of 0 to 1 in range. It should be noted that, if Str is close to 0, this means stripe like patterns and other surface properties with strong anisotropy, while if Str is close to 1, this means isotropic surface properties with no dependence of the surface on orientation. If the shaped Str is 0.30 or more, even if ghost lines form at the time of shaping, they will be hard to recognize.

Shaped Str can be measured as follows: First, a No. 5 test piece of JIS Z2241: 2022 having a direction perpendicular to the rolling direction as its long direction is taken from the plated steel sheet 1 being measured. At this time, the test piece is taken from a position of 100 mm or more from the end faces of the plated steel sheet 1. Next, by a tensile test based on JIS Z 2241:2022, the above test piece is given a 5% tensile strain in the long direction. Further, a laser microscope is used to measure the unevenness of the test piece surface after the tensile test at 8 mm×8 mm regions. The measurement conditions at this time are a measurement power of 20×, a resolution of the XY plane of 5 μm, and a resolution of the Z spatial plane of 0.1 nm for measurement connected. After that, the entire measurement region is filtered to remove unevenness of a period of 0.25 mm or less (i.e., low pass filter λs of 0.25 mm) to calculate the shaped Str.

As explained above, the plated steel sheet 1 of the present embodiment has a high strength and elongation and can maintain an excellent appearance even after press forming and other shaping. For this reason, the plated steel sheet 1 of the present embodiment is extremely useful for use in automobiles as roofs, hoods, fenders, doors, and other panel parts where high design sense is sought.

### <Method of Production of Plated Steel Sheet>

Next, one example of the method of production of the plated steel sheet 1 according to one embodiment of the present invention will be explained. The following explanation is intended to illustrate the characterizing method for producing the plated steel sheet 1 according to one embodiment of the present invention and is not intended to limit the plated steel sheet 1 to one produced by the following method of production.

The method of production of the plated steel sheet 1 of the present embodiment includes a casting step for casting a slab having the above specific chemical composition, a hot rolling step for hot rolling the cast slab, a cold rolling step for cold rolling the hot rolled steel sheet, an annealing step for holding the cold rolled steel sheet in a predetermined atmosphere and a predetermined temperature region, a cooling step for cooling the cold rolled steel sheet after annealing, a plating step for forming a plating layer 3 on the surface of the cold rolled steel sheet after cooling, and a skin pass rolling step for skin pass rolling the steel sheet after the plating step.

Below, the preferable conditions etc. of these steps will be explained.

### (Casting Step)

In the method of production of the plated steel sheet 1 of the present embodiment, the casting step is a step of casting a slab having the above specific chemical composition. The casting step includes use of a continuous casting machine provided with a plurality of reduction rolls adjoining each other in the slab conveyance direction and with a roll pitch of adjoining reduction rolls of 290 mm or less so as to perform light rolling reduction. It should be noted that, in this Description, “light rolling reduction” indicates rolling reduction having 0.6 mm or more rolling reduction gradient per 1 m of direction of progression of casting.

The plated steel sheet 1 of the present embodiment, as explained above, requires that the base steel sheet 2 have a distinctive microstructure comprised of hard phase fraction lower than conventional DP steel and with few band-like hard phase. To obtain such a microstructure, it is important to control the solidified structure at the time of casting to become columnar crystals. Specifically, in the casting step, by making the superheat ΔT (i.e., difference of molten steel temperature and solidification temperature of molten steel) of the molten steel having the above specific chemical composition 25° C. or more and making the cementite pressing force 450 tons or more, it is possible to suppress even center segregation while using a method different from the conventional center segregation countermeasure of controlling the solidified structure to a columnar crystal structure with an equiaxed crystal ratio of 15% or less. It should be noted that, the superheat ΔT is more preferably 30° C. or more. Further, the superheat ΔT is preferably 40° C. or less. It should be noted that, the molten steel temperature is the molten steel temperature inside a tundish and can be found by actual measurement. The solidification temperature can be found from the chemical composition of the molten steel using a known formula for estimation of solidification temperature.

The conventional countermeasure for improvement of center segregation is to reduce the superheat ΔT as much as possible (at least to less than 25° C.) and to increase the equiaxed crystal rate (at least increase it to more than 15%), but with such a conventional countermeasure, a sufficient effect of improvement cannot be obtained. In the present embodiment, by employing casting conditions completely different from the above-mentioned conventional countermeasures, i.e., the distinctive casting conditions of making the superheat ΔT 25° C. or more and making the cementite pressing force 450 tons or more to control the solidified structure to a columnar crystal structure, the negative segregation of Mn is suppressed. As a result, microsegregation of Mn is reduced and ghost lines can be sufficiently improved.

The equiaxed crystal rate (%) can be calculated by obtaining an etch print of the sheet thickness cross-section in the width direction of the slab, determining the boundaries of the columnar crystal structure and equiaxed crystal structure by visual examination, measuring the thickness (mm) of the equiaxed crystal structure of the slab and the thickness (mm) of the slab, and dividing the thickness of the equiaxed crystal structure by the thickness of the slab and multiplying the result by 100.

Further, in the casting step, by using a continuous casting machine with a roll pitch of a plurality of adjoining reduction rolls of 290 mm or less to as to perform light rolling reduction, it is possible to suppress the fluid motion of the molten steel at the time of solidification and reduce the local disparity of Mn at the center part. Due to this, it is possible to suppress center segregation of Mn. It should be noted that, the roll pitch of the plurality of adjoining reduction rolls is more preferably 280 mm or less.

### (Hot Rolling Step)

In the method of production of the plated steel sheet 1 of the present embodiment, the hot rolling step is the step of hot rolling the cast slab. In the hot rolling step, before the hot rolling, the slab is preferably heated to 1200° C. or more. By making the heating temperature 1200° C. or more, in the hot rolling, the rolling reaction force does not become excessively large and the targeted thickness is easily obtained. The upper limit of the heating temperature is not particularly prescribed, but from the viewpoint of economy, the heating temperature is preferably 1300° C. or less.

At the hot rolling step, the heated slab is rough rolled and finish rolled. In this case, in the plated steel sheet 1 of the present embodiment, as explained above, the base steel sheet 2 must have a distinctive microstructure comprised of a lower hard phase fraction than conventional DP steel, having few band-like hard phase, and having little local disparity of the hard phase fractions at the front and back of the base steel sheet 2. Such a microstructure can be obtained by selecting the various conditions of the rough rolling in the hot rolling step as follows and uniformly rolling the base steel sheet 2 at the front and back to make the hard phase uniformly disperse.

In the hot rolling step, the start temperature of the rough rolling is preferably 1150° C. or less. If the start temperature of the rough rolling is 1150° C. or less, it is possible to reduce the effect of heat robbed by the rolling rolls and uniformly roll the base steel sheet 2 at the front and back. On the other hand, the start temperature of the rough rolling is preferably 1050° C. or more. If the start temperature of the rough rolling is 1050° C. or more, it is possible to control the operation so that the rolling reaction force does not become excessively large.

Further, in the hot rolling step, the rolling reduction of the first pass of the rough rolling is preferably 45% or less. If the rolling reduction of the first pass of the rough rolling is 45% or less, it is possible to reduce the effect of heat robbed by the rolling rolls and uniformly roll the base steel sheet 2 at the front and back.

In the hot rolling step, the rough rolling is performed under the conditions of the following formula (1) so as to control the absolute value of the difference of the hard phase fractions at the 1t/8 to 4t/8 positions and the 4t/8 to 7t/8 positions of the sheet thickness “t” from the surface of the above-mentioned base steel sheet 2 to 0 to 8%:

$$200 ( ° C . \% / mm ) \leq ( start temperature of rough rolling \times rolling reduction of first pass ) / diameter of rolling rolls \leq 420 ( ° C . \% / mm ) \qquad ( 1 )$$

If performing the rough rolling under conditions satisfying the above formula (1), it is possible to reduce the effect of heat robbed by the rolling rolls and uniformly roll the base steel sheet 2 at the front and back. It should be noted that, in the above formula (1), “(start temperature of rough rolling×rolling reduction of first pass)/diameter of rolling rolls (work rolls)” is more preferably 350° C. %/mm or more and 420° C. %/mm or less.

In the hot rolling step, the end temperature of the finish rolling is preferably 800° C. or more. If the rolling end temperature of the finish rolling is 800° C. or more, it is possible to reduce the mean crystal grain size of the hot rolled steel sheet and final product, so it is possible to secure a sufficient yield strength and possible on top of that to obtain a high quality appearance after shaping. On the other hand, the upper limit of the rolling end temperature of the finish rolling is not particularly prescribed, but from the viewpoint of economy, the rolling end temperature of the finish rolling is preferably 980° C. or less.

Further, to satisfy formula (1), the diameter of the rolling rolls (work rolls) used in the rough rolling of the hot rolling step is preferably 100 mm or more. If the diameter of the rolling rolls is 100 mm or more, it becomes difficult for strain to concentrate at the surface contacting the rolling rolls and possible to uniformly roll the base steel sheet 2 at the front and back. On the other hand, the upper limit of the diameter of the rolling rolls is not particularly prescribed, but from the viewpoint of economy, is preferably 700 mm or less. It should be noted that, the rolling rolls used in the hot rolling step may also be heated in advance. If the rolling rolls are heated in advance, heat can be kept from being robbed from the base steel sheet 2 by the rolling rolls and unevenness of heat robbed from the base steel sheet 2 by the rolling rolls can be reduced.

The hot rolled steel sheet obtained in the above hot rolling step is coiled at a, for example, 450 to 700° C. coiling temperature. By making the coiling temperature 450° C. or more, the strength of the hot rolled steel sheet does not become excessively high and the load at the time of cold rolling after pickling can be reduced. On the other hand, by making the coiling temperature 700° C. or less, coarse ferrite and pearlite become hard to form in the structure of the hot rolled steel sheet and the uniformity of structure after annealing can be improved. As a result, a higher quality appearance after shaping can be obtained.

### (Cold Rolling Step)

The hot rolled steel sheet obtained by the hot rolling step is suitably pickled to remove the scale, then is sent on to the cold rolling step.

In the cold rolling step, for example, it is preferable to cold roll the hot rolled steel sheet so that the cumulative rolling reduction (i.e., cold rolling rate) becomes 65 to 90%. If controlling the cumulative rolling reduction to 65% or more, the desired sheet thickness can be secured and on top of that the cold rolling strain can be made to accumulate to refine the crystal grain size in the later annealing step and thereby raise the uniformity of structure and as a result enable a higher quality appearance after shaping to be obtained. On the other hand, if controlling the cumulative rolling reduction to 90% or less, it is possible to prevent the rolling load from becoming excessive and rolling becoming difficult.

### (Annealing Step)

The cold rolled steel sheet obtained by the cold rolling step is sent on to the annealing step where it is held in a predetermined atmosphere at a predetermined temperature range.

In the annealing step, the cold rolled steel sheet is preferably held in a reducing atmosphere, for example, at a holding temperature of the 750 to 900° C. temperature region, for a predetermined time. In this case, the “reducing atmosphere” indicates an atmosphere of mainly a reducing gas comprised of hydrogen and nitrogen or argon or another inert gas. To adjust the surface roughness Sa of the plated steel sheet 1 to 0.10 to 0.50 μm, the reducing gas used is a mixed gas of 2 to 15% concentration hydrogen and nitrogen. Reducing gas of such a concentration facilitates reduction at the surface of the base steel sheet 2 and enables improvement of the wettability with respect to the plating, therefore as a result it is possible to obtain a high quality appearance after shaping.

Further, to adjust the surface roughness Sa of the plated steel sheet 1 to 0.10 to 0.50 μm, the reducing atmosphere in the annealing step is one with a dew point of −5° C. to 10° C. A dew point of −5° C. or more facilitates reduction at the surface of the base steel sheet 2 and enables improvement of the wettability with respect to the plating, therefore as a result it is possible to obtain a high quality appearance after shaping. On the other hand, if the dew point is 10° C. or less, condensation becomes hard to occur at the production facilities and there is little liability of operation of the production facilities being impaired.

Further, in the annealing step, if the hydrogen concentration of the reducing atmosphere is outside of the 2 to 15% range or the dew point is outside of the −5° C. to 10° C. range, decarburization and demanganization from the steel sheet surface, a possible cause of uneven plating adhesion, will occur and the steel sheet surface layer will become soft, so the tensile strength of the base steel sheet 2 is liable to fall.

The holding temperature of the annealing step, as explained above, is preferably 750° C. or more. If the holding temperature of the annealing step is 750° C. or more, recrystallization of ferrite and reverse transformation from ferrite to austenite can be sufficiently promoted, therefore the desired microstructure can be easily obtained at the final product. Further, the holding temperature of the annealing step is preferably 900° C. or less. If the holding temperature of the annealing step is 900° C. or less, the desired microstructure fractions can be obtained and the grains can be made denser to obtain sufficient strength.

In the annealing step, the time period over which the above holding temperature is maintained, i.e., the holding time, is preferably 20 seconds or more. If the holding time of the annealing step is 20 seconds or more, recrystallization of ferrite and reverse transformation from ferrite to austenite can be sufficiently made to proceed, therefore in the final product, the desired microstructure becomes easier to obtain. Further, the holding time of the annealing step is preferably 300 seconds or less. If the holding time of the annealing step is 300 seconds or less, the desired microstructure fractions can be obtained. On top of this, the grains can be made denser and sufficient strength can be obtained.

### (Cooling Step)

After the annealing step, the cold rolled steel sheet is sent on to the cooling step. The cooling step is the step for cooling the cold rolled steel sheet heated in the annealing step.

In the cooling step, the cooling speed when cooling the cold rolled steel sheet is preferably 5° C./s or more. If the cooling speed is 5° C./s or more, it is possible to suppress excessive transformation to ferrite. On top of this, the amount of formation of martensite and other hard phases is increased and the desired strength becomes easier to obtain. Further, the cooling speed is preferably 50° C./s or less. If the cooling speed is 50° C./s or less, it is possible to cool the base steel sheet 2 more uniformly in the width direction.

In the cooling step, the stop temperature of the cooling is preferably 450° C. or more. If the stop temperature of the cooling is 450° C. or more, in the later plating step, reheating of the plating bath and alloying becomes unnecessary and the production costs can be kept down. Further, the stop temperature of the cooling is preferably 650° C. or less. If the stop temperature of the cooling is 650° C. or less, the amount of formation of martensite and other hard phases is increased and the desired strength becomes easy to obtain.

### (Plating Step)

After cooling, the cold rolled steel sheet is sent on to the plating step for forming a plating layer 3 on its surface. In the plating step, the surface of the cold rolled steel sheet is plated so as to form a predetermined plating layer 3 on the surface of the base steel sheet 2.

As the plating, for example, hot dip coating, alloyed hot dip coating, electroplating, or other known treatment can be employed. For example, as the plating, the surface of the base steel sheet 2 may be hot dip galvanized or may be hot dip galvanized, then alloyed. The specific conditions of the plating and the alloying are not particularly prescribed. Any suitable conditions known to persons skilled in the art can be employed.

It should be noted that, the amount of deposition of the plating layer 3 formed by the plating, from the viewpoint of adjusting the surface roughness Sa of the plated steel sheet 1 to 0.10 to 0.50 μm as explained above, is an amount of deposition of 20 g/m² or more and 120 g/m² or less as the amount of deposition per one surface of the base steel sheet 2.

If performing alloying in the plating step, the alloying temperature is preferably 480° C. or more. If the alloying temperature is 480° C. or more, carbides become difficult to form, therefore the desired ductility is easily secured. Further, the alloying temperature is preferably 600° C. or less. If the alloying temperature is 600° C. or less, the alloying proceeds fast and the productivity can be improved.

### (Skin Pass Rolling Step)

In the method of production of the plated steel sheet 1 of the present embodiment, after the plating step, the steel sheet, i.e., the plated steel sheet 1, is skin pass rolled. In other words, after the plating step, the steel sheet is sent on to the skin pass rolling step. In this skin pass rolling step, from the viewpoint of adjusting the surface roughness Sa of the plated steel sheet 1 to 0.10 to 0.50 μm, the skin pass rolling rate is 0.8% to 2.1%. If the skin pass rolling rate is within such a range, the surface of the plating layer 3 is smoothened while dislocations accumulate and yield point elongation become easily resolved.

The plated steel sheet 1 of the above embodiment can be produced by the above method of production.

It should be noted that the present invention is not limited to the above embodiment and the later mentioned examples etc. These can be suitably combined, switched, changed, etc. within a range not departing from the object and gist of the present invention.

Below, examples will be illustrated to more specifically explain the present invention, but the present invention is not limited by these examples.

### Examples

In the following examples, plated steel sheets according to one embodiment of the present invention (i.e., plated steel sheets of the invention examples) and plated steel sheets for comparison (i.e., plated steel sheets of the comparative examples) were produced under various conditions. The obtained plated steel sheets were evaluated for tensile strength, elongation at break, appearance after shaping, and other properties.

### (Production of Plated Steel Sheet)

First, a continuous casting machine provided with a plurality of reduction rolls arranged at a 290 mm or less roll pitch was used to cast slabs having the chemical compositions shown in the following Table 1 by a continuous casting method performing a 0.6 mm or more light rolling reduction having a 0.6 mm or more rolling reduction gradient per casting progression direction. The cementite pressing force was 450 tons or more. It should be noted that, the balance besides the constituents shown in Table 1 was Fe and impurities. Further, the superheat conditions of the examples are shown in the following Table 2. It should be noted that, the underlines given to the chemical compositions in Table 1 show values outside the scope of the present invention.

Next, the obtained slabs were treated by a hot rolling step, cold rolling step, annealing step, and cooling step under the conditions shown in the following Table 2 to obtain cold rolled steel sheets. Further, both of the surfaces of the obtained cold rolled steel sheets were plated to form galvannealed plating layers (GA) and obtain the Steel Sheet Nos. 1 to 26 of the steel sheets. It should be noted that, regarding the entries of the superheat ΔT in Table 2, the case where the superheat ΔT was 25° C. or more was indicated as “OK” while the case where it was less than 25° C. was indicated as “NG” (no good). It should be noted that, the equiaxed crystal ratio of the slab with a superheat ΔT of 25° C. or more was 15% or more and the equiaxed crystal ratio of the slab with a superheat ΔT of less than 25° C. was less than 15%.

Further, samples taken from the above cold rolled steel sheets were analyzed for chemical composition, whereupon it was confirmed that there were no changes from the chemical compositions of the slabs shown in Table 1.

### (Evaluation of Plated Steel Sheets)

The plated steel sheets of the Steel Sheet Nos. 1 to 26 obtained were measured for microstructures of the base steel sheets, surface properties before shaping (i.e., surface roughnesses Sa of plated steel sheet), mechanical strengths (i.e., tensile strengths and elongations at break) and surface properties after shaping (i.e., Sa and Str after shaping). These strengths and elongations and appearances after shaping were evaluated. It should be noted that, the rolling directions of plated steel sheets could be grasped, therefore were not judged by the above-mentioned method of judgment of the rolling direction.

In the evaluation, the case of satisfying the criteria of the tensile strength being 540 MPa or more, the elongation at break being 19% or more, the Sa after shaping being within 0.10 to 0.50 μm in range, and the Str after shaping being within 0.30 to 1.00 in range was evaluated as plated steel sheet excellent in strength and elongation and having an improved appearance after shaping. The results are shown in the following Table 2. It should be noted that, in Table 2, “Value of (formula 1)” indicates the calculated value of the “(start temperature of rough rolling×rolling reduction of 1st pass)/diameter of rolling rolls”. Further, the underlines attached to the various numerical values etc. in Table 2 indicate outside the scope of the present invention, production conditions where the plated steel sheet of the present invention cannot be obtained, or mechanical properties or surface properties after shaping not satisfying the above criteria.

TABLE 1

| | Chemical composition (mass %), bal.: Fe and impurities | | | | | | | | | | | | | | |
|---|---|---|---|---|---|---|---|---|---|---|---|---|---|---|---|
| Steel | C | Si | Mn | P | S | N | Al | O | Cr | Mo | B | Ti | Nb | Other elements | Remarks |
| A | 0.10 | 0.21 | 2.1 | 0.0858 | 0.0009 | 0.001 | 0.214 | 0.0012 | 0.15 | 0.20 | 0.010 | 0.09 | 0.07 | V: 0.27 | Inv. steel |
| B | 0.05 | 1.39 | 2.2 | 0.0297 | 0.0015 | 0.013 | 0.327 | 0.0111 | 0.40 | 0.15 | 0.006 | 0.06 | 0.08 | Ni: 0.30, Cu: 0.15 | Inv. steel |
| C | 0.07 | 1.41 | 1.8 | 0.0103 | 0.0012 | 0.002 | 0.590 | 0.0019 | 0.80 | 0.40 | 0.003 | 0.05 | 0.00 | | Inv. steel |
| D | 0.09 | 0.18 | 1.6 | 0.0068 | 0.0019 | 0.001 | 0.048 | 0.0010 | 0.20 | 0.15 | 0.007 | 0.10 | 0.05 | | Inv. steel |
| E | 0.10 | 1.09 | 1.0 | 0.0919 | 0.0037 | 0.002 | 0.106 | 0.0032 | 0.60 | 0.15 | 0.002 | 0.03 | 0.03 | Zr: 0.004, REM: 0.004 | Inv. steel |
| F | 0.08 | 0.42 | 1.2 | 0.0068 | 0.0100 | 0.008 | 0.685 | 0.0167 | 0.70 | 0.50 | 0.004 | 0.04 | 0.06 | Ca: 0.004 | Inv. steel |
| G | 0.06 | 1.33 | 2.1 | 0.0946 | 0.0163 | 0.001 | 0.471 | 0.0019 | 0.15 | 0.30 | 0.000 | 0.07 | 0.10 | Sn: 0.10, Sb: 0.10 | Inv. steel |
| H | 0.04 | 1.44 | 1.5 | 0.0951 | 0.0021 | 0.001 | 0.408 | 0.0028 | 0.30 | 0.30 | 0.008 | 0.08 | 0.02 | W: 0.08 | Inv. steel |
| I | 0.09 | 0.18 | 1.6 | 0.0068 | 0.0019 | 0.001 | 0.048 | 0.0010 | 0.01 | 0.15 | 0.007 | 0.10 | 0.05 | | Comp. steel |
| J | 0.09 | 0.18 | 1.6 | 0.0068 | 0.0019 | 0.001 | 0.048 | 0.0010 | 0.15 | 0.01 | 0.007 | 0.10 | 0.05 | | Comp. steel |
| K | 0.05 | 1.39 | 2.8 | 0.0297 | 0.0015 | 0.013 | 0.327 | 0.0111 | 0.40 | 0.15 | 0.006 | 0.06 | 0.08 | Sn: 0.10, Sb: 0.10 | Comp. steel |
| L | 0.04 | 1.81 | 1.5 | 0.0951 | 0.0021 | 0.001 | 0.408 | 0.0028 | 0.30 | 0.30 | 0.008 | 0.08 | 0.02 | | Comp. steel |
| M | 0.02 | 1.33 | 2.1 | 0.0946 | 0.0163 | 0.001 | 0.471 | 0.0019 | 0.15 | 0.30 | 0.000 | 0.07 | 0.10 | | Comp. steel |

TABLE 2

| | | Production conditions | | | | | | | | | |
|---|---|---|---|---|---|---|---|---|---|---|---|
| | | | Hot rolling step | | | | | | | | |
| | | | | | Rolling | | | | Cold rolling | Annealing step | |
| | | Casting | | Start temp. | reduction of | | End temp. | | step | H and N | |
| Steel | | step | Heating | of rough | 1st pass of | Value of | of finish | Coiling | Cum. rolling | mixed | Dew |
| sheet | | Superheat | temp. | rolling | rough rolling | formula 1 | rolling | temp | reduction | gas temp. | point |
| no. | Steel | (° C.) | (° C.) | (° C.) | (%) | (° C. %/mm) | (° C.) | (° C.) | (%) | (%) | (° C.) |
| 1 | A | OK | 1300 | 1150 | 45 | 370 | 900 | 650 | 65 | 2 | −5 |
| 2 | A | OK | 1300 | 1000 | 55 | 157 | 900 | 650 | 65 | 2 | −5 |
| 3 | A | OK | 1300 | 1150 | 55 | 166 | 700 | 650 | 65 | 2 | −5 |
| 4 | A | OK | 1300 | 1150 | 45 | 370 | 900 | 650 | 65 | 2 | −5 |
| 5 | A | OK | 1300 | 1150 | 45 | 370 | 900 | 650 | 65 | 2 | −5 |
| 6 | B | OK | 1300 | 1150 | 35 | 335 | 950 | 550 | 85 | 5 | 5 |
| 7 | B | OK | 1300 | 1150 | 35 | 335 | 950 | 550 | 85 | 5 | 5 |
| 8 | C | OK | 1250 | 1100 | 40 | 220 | 850 | 600 | 90 | 3 | 0 |
| 9 | C | OK | 1250 | 1100 | 40 | 110 | 850 | 750 | 90 | 3 | 0 |
| 10 | C | OK | 1250 | 1100 | 40 | 220 | 850 | 600 | 90 | 3 | 0 |
| 11 | D | OK | 1250 | 1150 | 45 | 207 | 900 | 450 | 80 | 2 | 0 |
| 12 | E | OK | 1200 | 1050 | 40 | 210 | 850 | 550 | 70 | 5 | −5 |
| 13 | E | OK | 1200 | 1050 | 40 | 115 | 850 | 550 | 55 | 5 | −5 |
| 14 | F | OK | 1200 | 1150 | 40 | 230 | 800 | 600 | 80 | 5 | 5 |
| 15 | G | OK | 1250 | 1150 | 25 | 240 | 800 | 650 | 65 | 10 | 10 |
| 16 | G | NG | 1250 | 1150 | 25 | 240 | 800 | 650 | 65 | 10 | 10 |
| 17 | G | OK | 1250 | 1150 | 25 | 240 | 800 | 650 | 65 | 10 | 10 |
| 18 | H | OK | 1250 | 1150 | 40 | 230 | 850 | 550 | 80 | 15 | 10 |
| 19 | H | OK | 1250 | 1150 | 40 | 230 | 850 | 550 | 80 | 15 | 10 |
| 20 | H | OK | 1250 | 1150 | 40 | 230 | 850 | 550 | 80 | 0 | 10 |
| 21 | H | OK | 1250 | 1150 | 40 | 230 | 850 | 550 | 80 | 15 | −40 |
| 22 | I | OK | 1250 | 1150 | 40 | 230 | 900 | 600 | 90 | 8 | −10 |
| 23 | J | OK | 1250 | 1100 | 40 | 220 | 800 | 450 | 80 | 12 | −5 |
| 24 | K | OK | 1250 | 1050 | 40 | 210 | 850 | 600 | 85 | 3 | 5 |
| 25 | L | OK | 1250 | 1150 | 40 | 230 | 850 | 650 | 85 | 2 | 10 |
| 26 | M | OK | 1200 | 1050 | 40 | 210 | 850 | 550 | 80 | 8 | −10 |

| | | | | | | | Microstructure | | | |
|---|---|---|---|---|---|---|---|---|---|---|
| | | | | | | | | | Area ratio | Absolute value |
| | Production conditions | | | | | | | | of band-like | of difference |
| | | | | | Plating | Skin pass | | | hard phase | of hard phase |
| | Annealing step | | Cooling step | | step | rolling step | Hard | | of 3t/8~5t/8 | fractions of |
| Steel | Holding | Holding | Cooling | Stop | Alloying | Skin pass | phase | Ferrite | position | 1t/8~4t/8, |
| sheet | temp | time | speed | temp. | temp. | rolling rate | fraction | fraction | of sheet | 4t/8~7t/8 |
| no. | (° C.) | (s) | (° C./s) | (° C.) | (° C.) | (%) | (%) | (%) | thickness t | (%) |
| 1 | 820 | 60 | 50 | 500 | 500 | 0.8 | 15 | 85 | 0 | 5 |
| 2 | 820 | 60 | 50 | 500 | 500 | 0.8 | 14 | 86 | 0 | 10 |
| 3 | 820 | 60 | 50 | 500 | 500 | 0.8 | 13 | 87 | 0 | 9 |
| 4 | 700 | 60 | 50 | 500 | 500 | 0.8 | 1 | 99 | 0 | 5 |
| 5 | 820 | 60 | 50 | 300 | 500 | 0.8 | 22 | 78 | 0 | 5 |
| 6 | 800 | 240 | 15 | 510 | 480 | 1.0 | 10 | 90 | 3 | 3 |
| 7 | 800 | 240 | 15 | 510 | 480 | 3.5 | 10 | 90 | 3 | 3 |
| 8 | 760 | 210 | 20 | 520 | 550 | 2.1 | 5 | 95 | 2 | 2 |
| 9 | 760 | 210 | 20 | 520 | 550 | 2.1 | 5 | 95 | 2 | 9 |
| 10 | 760 | 290 | 3 | 520 | 550 | 2.1 | 2 | 98 | 2 | 2 |
| 11 | 800 | 270 | 20 | 500 | 580 | 1.2 | 10 | 90 | 0 | 5 |
| 12 | 850 | 120 | 35 | 450 | 550 | 0.8 | 9 | 91 | 0 | 3 |
| 13 | 850 | 120 | 35 | 450 | 550 | 0.8 | 9 | 91 | 0 | 10 |
| 14 | 780 | 100 | 40 | 480 | 520 | 1.3 | 6 | 94 | 0 | 1 |
| 15 | 800 | 180 | 20 | 550 | 500 | 0.8 | 8 | 92 | 3 | 3 |
| 16 | 800 | 180 | 20 | 550 | 500 | 0.8 | 8 | 92 | 7 | 3 |
| 17 | 800 | 180 | 20 | 700 | 500 | 0.8 | 0 | 100 | 0 | 0 |
| 18 | 880 | 240 | 15 | 540 | 480 | 1.5 | 10 | 90 | 2 | 3 |
| 19 | 880 | 20 | 70 | 540 | 480 | 1.5 | 22 | 78 | 2 | 3 |
| 20 | 880 | 240 | 15 | 540 | 480 | 1.5 | 10 | 90 | 2 | 3 |
| 21 | 880 | 240 | 15 | 540 | 480 | 1.5 | 10 | 90 | 2 | 3 |
| 22 | 820 | 30 | 50 | 550 | 500 | 1.2 | 12 | 88 | 6 | 5 |
| 23 | 800 | 120 | 35 | 600 | 550 | 1.6 | 9 | 91 | 9 | 2 |
| 24 | 780 | 210 | 20 | 620 | 580 | 0.9 | 17 | 83 | 9 | 3 |
| 25 | 850 | 270 | 20 | 510 | 520 | 1.8 | 8 | 92 | 8 | 5 |
| 26 | 750 | 80 | 50 | 480 | 580 | 0.8 | 10 | 90 | 6 | 6 |

| | | | Surface | | | | | |
|---|---|---|---|---|---|---|---|---|
| | | | properties | | | | | |
| | Microstructure | | before shaping | Mechanical | | Surface properties | | |
| | | Size of | Plated steel | properties | | after shaping | | |
| Steel | Size of | hard | sheet surface | Tensile | Elongation | Shaped | | |
| sheet | ferrite | phase | roughness Sa | strength | at break | Sa | Shaped | |
| no. | (μm) | (μm) | (μm) | (MPa) | (%) | (μm) | Str | Remarks |
| 1 | 13.2 | 4.5 | 0.43 | 687 | 22 | 0.45 | 0.81 | Inv. ex. |
| 2 | 12.0 | 5.4 | 0.38 | 659 | 22 | 0.21 | 0.29 | Comp. ex. |
| 3 | 15.1 | 3.4 | 0.32 | 659 | 32 | 0.21 | 0.29 | Comp. ex. |
| 4 | 13.2 | 4.5 | 0.43 | 499 | 32 | 0.53 | 0.81 | Comp. ex. |
| 5 | 13.2 | 4.5 | 0.43 | 789 | 16 | 0.54 | 0.81 | Comp. ex. |
| 6 | 11.1 | 3.3 | 0.27 | 621 | 21 | 0.35 | 0.56 | Inv. ex. |
| 7 | 11.1 | 3.3 | 0.08 | 621 | 21 | 0.35 | 0.22 | Comp. ex. |
| 8 | 27.8 | 1.8 | 0.35 | 589 | 23 | 0.47 | 0.61 | Inv. ex. |
| 9 | 29.2 | 2.1 | 0.32 | 589 | 23 | 0.66 | 0.21 | Comp. ex. |
| 10 | 27.8 | 1.8 | 0.35 | 530 | 30 | 0.42 | 0.66 | Comp. ex. |
| 11 | 17.2 | 2.8 | 0.37 | 547 | 30 | 0.43 | 0.71 | Inv. ex. |
| 12 | 18.2 | 2.6 | 0.41 | 611 | 24 | 0.48 | 0.89 | Inv. ex. |
| 13 | 22.3 | 2.3 | 0.45 | 611 | 24 | 0.75 | 0.17 | Comp. ex. |
| 14 | 16.2 | 2.8 | 0.32 | 559 | 30 | 0.44 | 0.65 | Inv. ex. |
| 15 | 8.9 | 3.2 | 0.31 | 617 | 22 | 0.40 | 0.78 | Inv. ex. |
| 16 | 8.9 | 3.2 | 0.31 | 620 | 23 | 0.51 | 0.15 | Comp. ex. |
| 17 | 8.9 | 3.2 | 0.31 | 533 | 31 | 0.44 | 0.79 | Comp. ex. |
| 18 | 20.2 | 3.3 | 0.43 | 561 | 29 | 0.45 | 0.53 | Inv. ex. |
| 19 | 20.2 | 3.3 | 0.43 | 810 | 17 | 0.45 | 0.53 | Comp. ex. |
| 20 | 20.2 | 3.3 | 0.78 | 522 | 29 | 0.91 | 0.23 | Comp. ex. |
| 21 | 20.2 | 3.3 | 0.65 | 522 | 29 | 0.76 | 0.19 | Comp. ex. |
| 22 | 11.2 | 3.7 | 0.22 | 564 | 27 | 0.61 | 0.22 | Comp. ex. |
| 23 | 17.9 | 3.8 | 0.24 | 536 | 28 | 0.68 | 0.29 | Comp. ex. |
| 24 | 11.9 | 4.8 | 0.31 | 812 | 19 | 0.78 | 0.18 | Comp. ex. |
| 25 | 22.3 | 3.1 | 0.34 | 667 | 23 | 0.66 | 0.21 | Comp. ex. |
| 26 | 12.3 | 4.1 | 0.30 | 659 | 20 | 0.81 | 0.27 | Comp. ex |

As shown in Table 2, in each of the invention examples of Steel Sheet Nos. 1, 6, 8, 11, 12, 14, 15, and 18 with a chemical composition, microstructure, and surface roughness Sa of the plated steel sheet within the scope of the present invention, the tensile strength was 540 or more, the elongation at break was 19% or more, the Sa after shaping was within a range of 0.10 to 0.50 μm, and the Str after shaping was within a range of 0.30 to 1.00. In other words, it was learned that the plated steel sheets of the invention examples were all excellent in strength and elongation and had much more improved appearance after shaping.

On the other hand, in each of the comparative examples of Steel Sheet Nos. 2, 3, 9, and 13 with an absolute value of the difference of the hard phase fractions at the 1t/8 to 4t/8 positions and 4t/8 to 7t/8 positions outside the scope of the present invention, the Sa or Str after shaping was outside the suitable range and a good appearance after shaping could not be obtained. Further, in each of the comparative examples of Steel Sheet Nos. 4, 5, 10, 17, and 19 with a hard phase fraction outside the scope of the present invention, the tensile strength or elongation at break was outside the suitable range and excellent strength and elongation could not be obtained. It should be noted that, in each of the comparative examples of Steel Sheet Nos. 4 and 5, the Sa after shaping was also outside the suitable range and a good appearance after shaping could not be obtained. Further, in each of the comparative examples of Steel Sheet Nos. 7, 20, and 21 with a surface roughness Sa of the plated steel sheet outside the scope of the present invention, the Sa or Str after shaping was outside the suitable ranges and a good appearance after shaping could not be obtained. Further, in each of the comparative examples of Steel Sheet Nos. 16 and 22 to 26 with an area ratio of band-like hard phase etc. outside the scope of the present invention, the Sa or Str after shaping was outside the suitable ranges and a good appearance after shaping could not be obtained.

### REFERENCE SIGNS LIST

1. plated steel sheet
2. base steel sheet
3. plating layer

1. Plated steel sheet comprised of
a base steel sheet and
a plating layer provided on a surface of the base steel sheet,
in which plated steel sheet,
a chemical composition of the base steel sheet further comprises, by mass %,
C: 0.03 to 0.10%,
Si: 0.01 to 1.50%,
Mn: 1.0 to 2.5%,
Al: 0.005 to 0.700%,
Cr: 0.15 to 0.80%,
Mo: 0.15 to 0.50%,
Ti: 0.03 to 0.10%,
P: 0.1000% or less,
S: 0.0200% or less,
N: 0.015% or less,
O: 0.0200% or less,
B: 0 to 0.010%,
Nb: 0 to 0.10%,
V: 0 to 0.50%,
Ni: 0 to 1.00%,
Cu: 0 to 1.00%,
W: 0 to 1.00%,
Sn: 0 to 1.00%,
Sb: 0 to 0.20%,
Ca: 0 to 0.010%,
Zr: 0 to 0.010%,
REM: 0 to 0.010%, and
bal.: Fe and impurities,
a microstructure of the base steel sheet comprises, by area %,
ferrite: 80 to 97%,
a hard phase: 3 to 20%,
an area ratio of a band-like hard phase at 3t/8 to 5t/8 positions of a sheet thickness “t” is 0 to 5%,
an absolute value of a difference of hard phase fractions at 1t/8 to 4t/8 positions and 4t/8 to 7t/8 positions of the sheet thickness “t” from a surface of the base steel sheet is 0 to 8%, and
a surface roughness Sa of the plated steel sheet is 0.10 to 0.50 μm.

2. The plated steel sheet according to claim 1, wherein the chemical composition of the base steel sheet further comprises, by mass %, one or more elements selected from a group comprising
B: 0.0001 to 0.010%,
Nb: 0.001 to 0.10%,
V: 0.001 to 0.50%,
Ni: 0.001 to 1.00%,
Cu: 0.001 to 1.00%,
W: 0.001 to 1.00%,
Sn: 0.001 to 1.00%,
Sb: 0.001 to 0.20%,
Ca: 0.0001 to 0.010%,
Zr: 0.0001 to 0.010%, and
REM: 0.0001 to 0.010%.

3. The plated steel sheet according to claim 1, wherein, in the microstructure of the base steel sheet, the hard phase is 5% or more.

4. The plated steel sheet according to claim 1, wherein the absolute value of the difference in hard phase fractions at the 1t/8 to 4t/8 positions and 4t/8 to 7t/8 positions of sheet thickness “t” from the surface of the base steel sheet is 5% or less.

5. The plated steel sheet according to claim 1, wherein a tensile strength of the plated steel sheet is 540 MPa or more.

6. The plated steel sheet according to claim 1, wherein a mean crystal grain size of the ferrite is 5.0 to 30.0 μm and a mean crystal grain size of the hard phase is 1.0 to 5.0 μm.

7. The plated steel sheet according to claim 1, wherein the hard phase is comprised of at least one of martensite, bainite, tempered martensite, and pearlite.
